(19) United States
(12) Patent Application Publication
(10) Pub. No.: US 2026/0233772 A1
(43) Pub. Date: Aug. 13, 2026

(54) GLAZING BAR INSERT HOLDING DEVICE FOR A GLASS PANE DURING TRANSPORT

(71) Applicant: Glaston Germany GmbH, Neuhausen-Hamberg (DE)

(72) Inventor: Gennadi Schadrin, Remchingen (DE)

(73) Assignee: Glaston Germany GmbH, Neuhausen-Hamberg (DE)

(21) Appl. No.: 19/531,000

(22) Filed: Feb. 5, 2026

(30) Foreign Application Priority Data
Feb. 7, 2025 (DE) 102025104619.0

(51) Int. Cl. B62B 3/10; B65G 61/00; B65G 67/02

(52) U.S. Cl. CPC B62B 3/108; B65G 61/00; B65G 67/02; B65G 2201/0217

(57) ABSTRACT

A holding device, a transport trolley, and a method for transporting a glazing bar insert in connection with the manufacture of an insulating glass pane are described. A glazing bar insert has a muntin bar positioned where the muntin bar extends vertically. The holding device has a muntin bar end holding mechanism with a loading direction and loads the glazing bar insert by engaging a muntin bar end of the muntin bar with the holding device. The holding device is transported with the glazing bar insert to an automatic muntin bar station. The glazing bar insert is unloaded by taking it out from the holding device with a gripping device in the opposite direction to the loading direction and rotating it until the muntin bar extends horizontally. The glazing bar insert is inserted by the automatic muntin bar station into a frame-shaped spacer wherein the muntin bar extends horizontally.

### CROSS-REFERENCE TO RELATED APPLICATIONS

This application claims priority to the German application number 10 2025 104 619.0 filed on Feb. 7, 2025, the entire content of which is fully incorporated herein with this reference.

### DESCRIPTION

### Field of the Invention

The invention relates to the manufacture of an insulating glass pane with a glazing bar insert. Such insulating glass panes have been manufactured for a long time by inserting a glazing bar insert into a frame-shaped spacer before placing a second glass plate on top of the spacer applied to a first glass plate.

### Background of the Invention

An insulating glass pane of the type mentioned above is known, for example, from DE 10 2004 043 581 A1. The insulating glass pane has a frame-shaped spacer consisting of a thermoplastic spacer strand. A muntin bar holder designed as a muntin bar endpiece is disclosed, which has means for anchoring to the spacer (tapered pins). In addition, DE 10 2019 123 700 A1 discloses an insulating glass pane wherein the frame-shaped spacer is formed by placing two paste-like spacer strands on top of each other, which then solidify, the height of which together form the height of the spacer. A spacer strand is applied to each of the two glass plates. Before joining the two glass plates, a muntin grid is inserted into the spacer strand of one of the glass plates and attached to the spacer strand. The second glass plate is then placed on top so that the spacer and the glazing bar insert are located between the two glass plates.

Production takes place on a production line comprising several stations, at which various steps are carried out during the assembly of the insulating glass pane. One of the stations is a muntin bar station, at which the glazing bar insert is inserted manually by a worker. In practice, it is common to hang prefabricated glazing bar inserts on transport trolleys having cantilever arms and to push the loaded transport trolleys to the muntin bar station. The worker then takes the glazing bar inserts out from the transport trolley in order to insert them into the spacer of the glass plate standing in the muntin bar station.

As already described in DE 10 2004 043 581 A1, handling glazing bar inserts is not entirely easy, especially if they are intended for a larger insulating glass pane. The glazing bar insert does not behave like a rigid structure before it is inserted, which makes it difficult to position such an arrangement exactly at the predetermined location on the first attempt. In the process, the glazing bar insert may deform and/or damage the thermoplastic spacer, which is still soft, when attempting to position it in the space surrounded by the spacer. Therefore, attempts have always been made to avoid deforming and/or applying force to a spacer strand made of a paste-like material that has not yet hardened after it has been applied to the first glass plate, in order not to impair the appearance of the spacer in the finished insulating glass pane.

It may be an object of the invention to improve the handling and transport of glazing bar inserts in connection with the manufacture of insulating glass panes, in particular, during the automated insertion of the glazing bar inserts.

This object may be achieved by a holding device having the features specified in claim 1, a transport trolley having the features specified in claim 7 and a method having the features specified in claim 12. Advantageous further embodiments of the invention are subject of dependent claims.

### SUMMARY OF THE INVENTION

A holding device, according to the invention for holding a glazing bar insert for an insulating glass pane during a transport process, comprises a muntin bar end holding mechanism with a loading direction. The loading direction extends along a muntin bar of a glazing bar insert loaded into the holding device. The glazing bar insert comprises at least one muntin bar. The glazing bar insert may consist of a single muntin bar. However, the glazing bar insert may also contain an arrangement of several intersecting muntin bars. Such an arrangement is sometimes also referred to as a “muntin grid”. A muntin bar may be formed by an elongated and/or strung-out muntin bar profile. A muntin bar may have two ends configured for attachment to the spacer. The muntin bar profile can be designed as a hollow profile. A muntin bar can also be composed of several muntin bar profiles. The muntin bar profiles can be thin-walled hollow profile rods. The glazing bar insert contains at least one elongated muntin bar profile having a muntin bar end facing the spacer. The holding device can be loaded with the glazing bar insert by engaging the glazing bar insert in the area of a free end of a muntin bar with the muntin bar end holding mechanism. The free end of the muntin bar can be engaged with the holding device along the longitudinal direction of the muntin bar, in particular, parallel to the longitudinal direction of the muntin bar.

In a method according to the invention for transporting a glazing bar insert in connection with the manufacture of an insulating glass pane, the glazing bar insert is positioned so that said at least one muntin bar extends vertically. The glazing bar insert may have a long side and a short side, in particular, if it is intended for a non-square insulating glass pane. Such a glazing bar insert may be positioned upright on its short edge before loading it into the holding device so that the long side of the glazing bar insert extends vertically. The holding device is loaded with the glazing bar insert by bringing a free end of said at least one muntin bar along a loading direction into engagement with the holding device until the glazing bar insert rests against a positioning stop associated with the holding device. The glazing bar insert can be inserted into the holding device with a free end of said at least one muntin bar in such a way that a long side of the glazing bar insert held by the holding device extends vertically. The holding device is transported with the glazing bar insert, particularly in a way of keeping it positioned upright on its short edge, to an automatic muntin bar station. The glazing bar insert is unloaded by taking it out from the holding device with a gripping device in a direction opposite to the loading direction. The loading direction may coincide with the plumb line.

The glazing bar insert is then rotated by means of the gripping device until at least one muntin bar, in particular, the long side of the glazing bar insert, extends horizontally. When assembling the insulating glass pane, the glass plates are usually transported through the production line in such a way that their long side extends horizontally. The glazing bar insert, in particular, with its long side extending horizontally, is inserted into the frame-shaped spacer by the automatic muntin bar station. The insulating glass pane may contain at least two glass plates and a frame-shaped spacer made of a plastic-based material. The spacer may have been applied to a first glass plate in a manner known per se by applying a paste-like spacer strand, which subsequently solidifies, to the first glass plate in a frame-like manner. The spacer strand may be a paste-like spacer strand made of a thermoplastic material and/or a reactively cross-linking material, which subsequently solidifies. The first glass plate with the spacer is fed to the muntin bar station in a manner known per se, for example via a horizontal conveyor, before the glazing bar insert is inserted. The muntin bar station can be an automatic glazing bar insert assembly station. The muntin bar station can contain several processing heads. Each of the processing heads is designed to receive a muntin bar end and embed it into the spacer strand. After the glazing bar insert has been inserted, the glass pane can be conveyed to a pressing station and connected to another glass pane in a manner known per se, so that the spacer and the glazing bar insert are located between the two glass plates. In the finished insulating glass pane, the spacer and the glazing bar insert are arranged between the two glass plates.

A transport trolley, according to the invention for transporting several glazing bar inserts for insulating glass panes, has a loading direction, which can particularly be oriented along the plumb line. The transport trolley can be moved manually by a worker or an operator. The transport trolley comprises several holding devices arranged next to each other transversely to the loading direction, each for one glazing bar insert, in particular, positioned upright on its short edge. Each of the holding devices is assigned a positioning stop which defines the position of the glazing bar insert after a free end of said at least one muntin bar has been brought into engagement with this holding device along the loading direction during a loading process. Each of the holding devices can be loaded with a glazing bar insert having at least one muntin bar by bringing a free end of said at least one muntin bar into engagement with this holding device along a loading direction until the glazing bar insert rests against the positioning stop assigned to this holding device. When loading the holding device, the positioning stop can limit the displacement along the loading direction of the glazing bar insert engaged with the holding device.

The invention may have (but which are not necessary) significant advantages: (1) The method can be used, in particular, for the automatic insertion of a glazing bar insert into a frame-shaped spacer during the manufacture and/or assembly of an insulating glass pane. (2) Only one single glazing bar insert is held in each holding device. This enables sorting, orderly transport, and easy removal of glazing bar inserts. Furthermore, it prevents glazing bar inserts from falling off the transport trolley and/or being damaged during transport. (3) The glazing bar inserts can be sorted into a sequence that corresponds to the sequence in which the associated insulating glass panes are assembled on the production line as early as during loading of the holding devices and/or the transport trolley. This eliminates the need for sorting at the muntin bar station, making it very easy to implement automatic feeding there. (4) The muntin bar end resting against the positioning stop ensures that the glazing bar insert is in a defined position in the holding device. This can facilitate automatic removal of the glazing bar insert, for example by a robot arm. (5) The holding device is particularly well suited for holding glazing bar inserts of different designs and sizes. Both small and large glazing bar inserts can be securely held and positioned in the same holding device. In addition, glazing bar inserts consisting of only a single muntin bar can also be held and positioned in the same holding device. (6) The holding device and the transport trolley enable taking up uprightly positioned glazing bar inserts (including vertically positioned single muntin bars), thus enabling space-saving and safe transport of glazing bar inserts.

In a further embodiment of the invention, it may be provided that, when loading the holding device, a lower free end of said at least one muntin bar is inserted into the holding device from above. For unloading, the muntin bar held in the holding device by its lower free end can be gripped in its middle section by the gripping device, and the glazing bar insert can be pulled upwards out of the holding device. The gripping device can rotate the glazing bar insert until the muntin bar held therein extends horizontally. For this purpose, the gripping device can be rotatably mounted on a movable robot arm. The gripping device can include a connection for a robot arm. The gripping device can be couplable to a rotary drive and/or include a rotary drive. The gripping device thus takes the glazing bar insert out from the holding device and then rotates it into the orientation required for insertion into the muntin bar station. In particular, the gripping device can grip the glazing bar insert during unloading exclusively in the middle section of that muntin bar which is held in the holding device. This can enable a space-saving and simple design of the gripping device.

The gripping device can grip the muntin bar held in the holding device with two pairs of grippers spaced apart from each other. Each gripper pair can contain two gripping elements. The gripping elements can be moved closer to each other when gripping the muntin bar. For this purpose, each of the gripping elements can be coupled to a gripping drive. The gripping device can contain the gripping drive, for example a pneumatic cylinder. A first gripping element of the first gripper pair can be coupled to a first gripping element of the second gripper pair via a first connecting bridge. A second gripping element of the first gripper pair can be coupled to a second gripping element of the second gripper pair via a second connecting bridge. This can simplify a synchronous gripping movement of the gripping elements in both gripper pairs. The two pairs of grippers can be spaced apart in the longitudinal direction of a muntin bar to be gripped. This spacing can be selected to be slightly greater than the maximum possible height of cross muntin bars, and can be 8 mm to 45 mm. This spacing can ensure that even muntin bars can be gripped in their middle, which have a cross muntin bar there. In an embodiment, this spacing can be variable. The latter can enable additional gripping of the cross muntin bar. The gripping device can have a support for a cross muntin bar. This can improve the take-out and transfer of unstable glazing bar inserts or muntin grids by the gripping device.

In a further embodiment of the invention, the holding device may comprise a housing with a base side, a loading side, and two side walls. The loading side is opposite the base side. The side walls extend from the base side to the loading side. The loading direction is directed from the loading side to the base side. The housing has a recess and/or an opening in the area of the base side for a muntin bar end engaged with the holding device. A positioning stop for a muntin bar end can be arranged in the region of said recess and/or opening. The opening in the base side can extend into the side walls. The positioning stop can be contained in the holding device. Alternatively, an external positioning stop may be assigned to the holding device. The muntin bar end holding mechanism may include at least one clamping device. The clamping device is configured to clamp a glazing bar insert engaged with the holding device in the area of a free muntin bar end. A free end of said at least one muntin bar of the glazing bar insert can be engaged with the clamping device along the loading direction. After loading the holding device, the muntin bar end clamping device can clamp a free end of a muntin bar. The muntin bar end holding mechanism can have a first clamping device and, in the loading direction downstream thereof, a second clamping device. The holding device can also be mounted on a conveyor belt or a conveyor chain in order to transport glazing bar inserts to the muntin bar station.

In a further embodiment, the clamping device may contain at least two opposing muntin bar clamps. In particular, the clamping device may comprise at least one pair of two muntin bar clamps being arranged opposite to each other. A second pair of muntin bar clamps may be arranged in the loading direction downstream of a first pair of muntin bar clamps. Each muntin bar clamp can form a guide means and/or a holding means for a muntin bar of a glazing bar insert. A muntin bar clamp can comprise a roller and/or a slide guide. The muntin bar clamps can clamp and hold a muntin bar from opposite sides. At least one of the muntin bar clamps can be movable transversely to the loading direction and/or transversely to the longitudinal direction of the muntin bar to be clamped. A muntin bar engaged with the muntin bar end holding mechanism can thus be clamped transversely to the loading direction. This can ensure that the glazing bar insert is held securely during transport. Unintentional falling out of the holding device can be prevented. The movable muntin bar clamp can be spring-loaded in the direction of the other muntin bar clamp. The clamping device can have an insertion region that tapers in loading direction. In the insertion region of the clamping device, the distance between the two muntin bar clamps can decrease when viewed in the loading direction. At least one of the two muntin bar clamps may have a curved or slanted section in the insertion region. This ensures that when a muntin bar end is inserted into the muntin bar end holding mechanism, the muntin bar end pushes a spring-loaded muntin bar clamp aside and is thus easily clamped by the two opposing muntin bar clamps. This allows for a simple design of the holding device, as no drive is required to open and close the clamping device.

In a further embodiment of the invention, the transport trolley may have a coupling for coupling the transport trolley to an automatic muntin bar station. This allows the transport trolley pushed by a worker to the muntin bar station to be parked there in a defined position so that the glazing bar inserts can be taken out automatically. The transport trolley may have at least one additional support for large glazing bar inserts. The additional support may include an extendable support plate. The support plate may support from below a glazing bar insert held in the holding device. The additional support may include a side guide. The side guide may be arranged above the holding devices. Each of the holding devices may be assigned a side guide. The side guide may support a glazing bar insert transversely to a plane in which this glazing bar insert extends. The transport trolley may contain 20 to 80, in particular, 45 to 55, holding devices. Each of the holding devices may have a muntin bar end holding mechanism with a loading direction for uprightly positioned glazing bar inserts. The loading direction may be oriented vertically downward so that a lower free end of a vertically extending muntin bar can be engaged with either one of the holding devices of the transport trolley. All holding devices of the transport trolley may be of the same design. The positioning stop can extend transversely to the loading direction, in particular, along all holding devices of the transport trolley. The positioning stop can be formed by a positioning surface on a base plate of the transport trolley. The positioning stop can be configured for positioning a glazing bar insert in such a way that it limits an insertion movement of a muntin bar into the holding device in the insertion direction. The transport trolley can have a cleaning channel for the positioning stop. The cleaning channel can be formed by the recesses and/or openings in the housing of the holding devices arranged next to each other. The cleaning channel can extend transversely to the loading direction.

### BRIEF DESCRIPTION OF THE DRAWINGS

Further details and advantages of the invention are explained in embodiments of the invention with reference to the accompanying drawings. Identical and corresponding components are provided with corresponding reference symbols.

FIG. 1 shows a perspective view of an insulating glass pane with a glazing bar insert,

FIG. 2 shows a perspective view of a transport trolley according to the invention with several holding devices according to the invention,

FIG. 3 shows a top view of a holding device according to the invention with a glazing bar insert being inserted,

FIG. 4 shows a view of the holding device of FIG. 3 cut along the section A-A of FIG. 3,

FIG. 5 shows a perspective view of a schematically represented robot arm taking a glazing bar insert out from the transport trolley,

FIG. 6 shows a view similar to FIG. 5 during the further course of unloading,

FIG. 7 shows a perspective view of the transport trolley and the robot arm in front of an automatic muntin bar station,

FIG. 8 shows a gripping device according to the invention for gripping a glazing bar insert,

FIG. 9 shows the gripping device of FIG. 8 gripping a vertically extending muntin bar, and

FIG. 10 shows the gripping device of FIG. 8 gripping a vertically extending muntin bar which has a centrally attached cross muntin bar.

### DETAILED DESCRIPTION OF EMBODIMENTS OF THE INVENTION

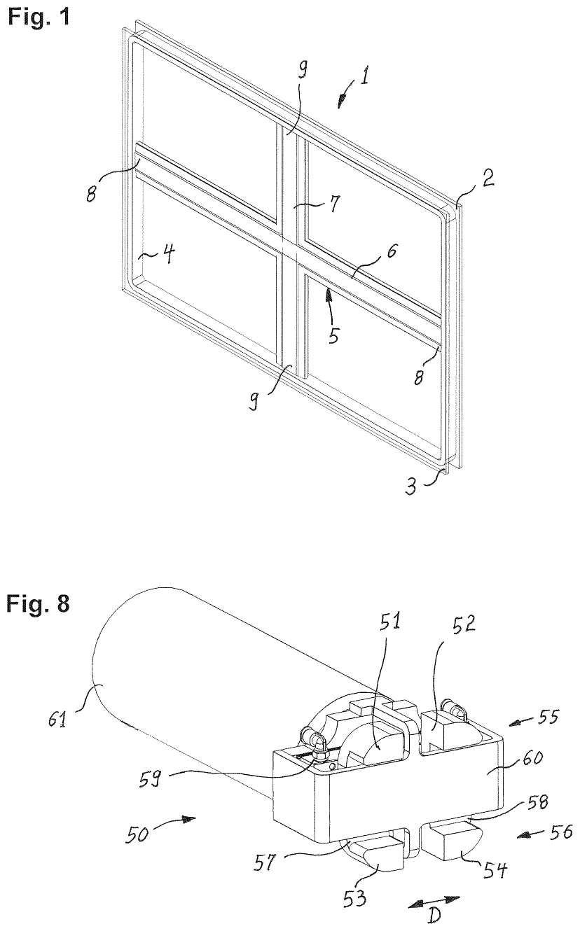

FIG. 1 shows a rectangular insulating glass pane 1, which contains a first glass plate 2, a second glass plate 3, a frame-shaped spacer 4, and a glazing bar insert 5. The glazing bar insert 5 is designed as a muntin cross and comprises a horizontally extending muntin bar 6 and a cross muntin bar 7. The muntin bar 6 has two muntin bar ends 8 which are attached to the spacer 4. The cross muntin bar 7 also has two muntin bar ends 9 attached to the spacer 4. The muntin bars 6, 7 are thin-walled hollow profiles. The long side of the insulating glass pane 1 and of the glazing bar insert 5 extend horizontally. The spacer 4 is formed by a paste-like strand of a plastic-based material that subsequently solidifies, which is applied to the glass plate 2 in a manner known per se.

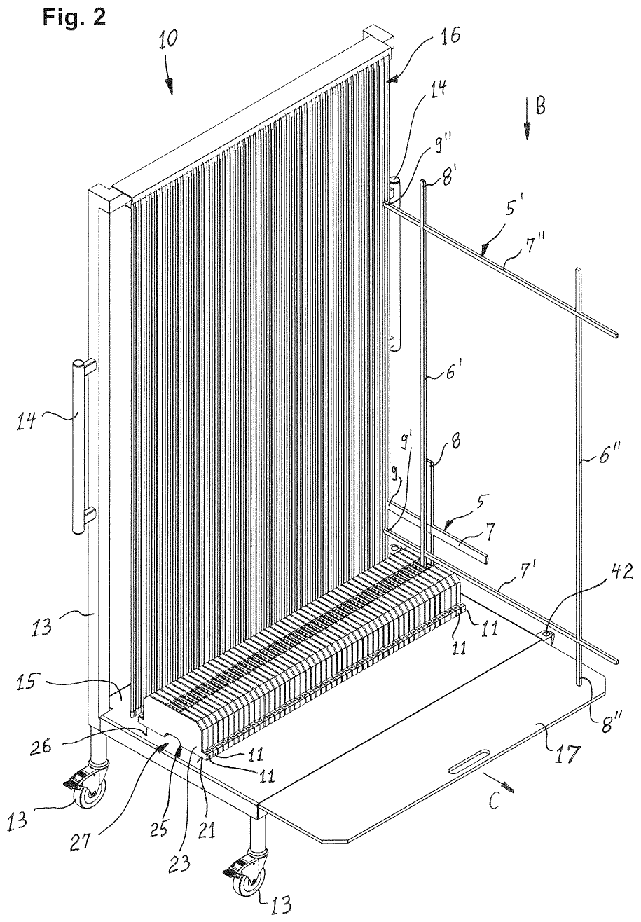

FIG. 2 shows a transport trolley 10 according to the invention, which has a plurality of adjacent holding devices 11 according to the invention. The transport trolley 10 has a frame 12 made of steel profiles and can be moved on four rollers 13. The rollers can be designed as swivel casters or fixed casters as required. Two handles 14 are attached to the frame 12, which can be used by a worker to move the transport trolley 10. The holding devices 11 sit on a base plate 15 of the transport trolley 10 and can be loaded from top to bottom along a loading direction B with various glazing bar inserts. In FIG. 2, the first holding device 11 is loaded with a muntin cross 5, which has a vertically extending muntin bar 6 and a cross muntin bar 7. The second holding device 11 is loaded with a large upright muntin grid 5′, which consists of two vertical muntin bars 6′ and 6″ and two cross muntin bars 7′ and 7″. During loading, the glazing bar inserts 5 and 5′ are inserted into the holding devices 11 along the loading direction B. The lower free end 8 of the muntin bar 6 and the lower free end 8′ of the muntin bar 6′ are inserted into the respective holding device 11 and thereby engaged with the respective holding device 11.

The transport trolley 10 has additional supports 16, in particular, for large glazing bar inserts, to guide and support ends 9, 9′, 9″ of cross muntin bars 7, 7′, 7″. The additional supports 16 extend along the plumb line and are attached to the frame 12 at a distance from each other. The additional supports 16 can be formed by bars or bands, in particular, elastic bands. Below the base plate 15, a further additional support 17, in particular, for large glazing bar inserts 5′, is arranged in the form of a support plate. The additional support 17 can be pulled out along the arrow C. After extension, the additional support 17 can support large muntin grids 5′ at a lower free end 8″ of vertically extending muntin bars 6″ which are not engaged with a holding device 11, see FIG. 2.

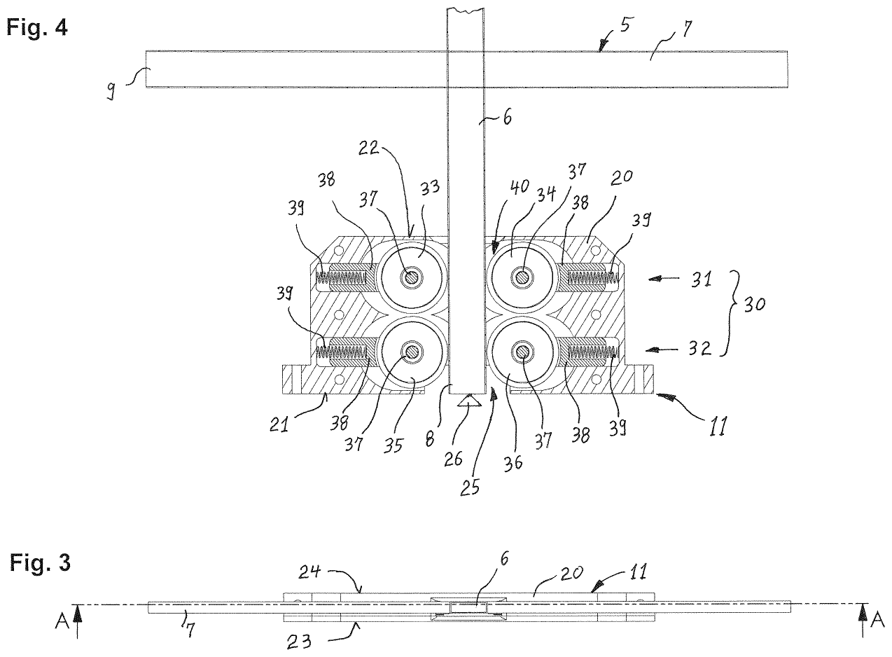

Each of the holding devices 11 has a housing 20 with a base side 21, a loading side 22, and two side walls 23 and 24, see FIGS. 3 and 4. The housing 20 is mounted with its base side 21 on the base plate 15. The housing 20 has a recess 25. A positioning stop 26 is arranged in the region of the recess 25. The positioning stop 26 is shown schematically in FIG. 4 and is formed in the transport trolley 10 by the upper side of the base plate 15, see FIG. 2. In the transport trolley 10, the recesses 25 of the holding devices 11 arranged next to each other form a cleaning channel 27 for cleaning the positioning stop 26. If dirt falls into the holding devices 11 from above, it can collect on the positioning stop 26 and impair the precise positioning of the glazing bar inserts 5, 5′. The same applies if there are still chips on or in the muntin bar ends 8, 8′ that are inserted into the holding devices 11. The cleaning channel 27 makes the positioning stop 26 easily accessible and allows it to be cleaned in a simple manner, for example by blowing compressed air through it.

The holding device 11 has a muntin bar end holding mechanism 30, which consists of two clamping devices 31 and 32. The second clamping device 32 is arranged in the loading direction B downstream of the first clamping device 31. The clamping device 31 contains two opposing muntin bar clamps 33 and 34. The clamping device 32 contains two opposing muntin bar clamps 35 and 36. Each muntin bar clamp 33, 34, 35, 36 is formed by a clamping roller which is mounted so as to rotate freely on an axle 37. Each axle 37 is mounted on a sliding piece 38, which is mounted in the housing 20 in a way so that it can be moved transversely to the loading direction B. Each sliding piece 38 is spring-loaded and is pressed against the muntin bar 6 by a helical spring 39. If the muntin bar 6 is pulled out of the holding device 11, the distance between the muntin bar clamp 35 and the muntin bar clamp 36 and the distance between the muntin bar clamp 33 and the muntin bar clamp 34 decrease. The curved peripheral surfaces of the muntin bar clamps 33 and 34 form an insertion region 40 that tapers in the loading direction B.

When loading the holding device 11, the lower free end 8 is inserted into the holding device 11 in the loading direction B. Due to the insertion region 40, the muntin bar end 8 pushes the two muntin bar clamps 33 and 34 away from each other against the force of the helical springs 39 and thus enters between the muntin bar clamps 33 and 34. The same happens with the muntin bar clamps 35 and 36 as the muntin bar end 8 is further inserted into the muntin bar end holding mechanism 30. The insertion movement of the muntin bar end 8 in loading direction B is limited by the fact that the muntin bar end 8 touches the positioning stop 26. The muntin bar end 8 engaged with the holding device 11 is then in the position shown in FIG. 4 and is fixed in the muntin bar end holding mechanism 30 in a predetermined and secure way.

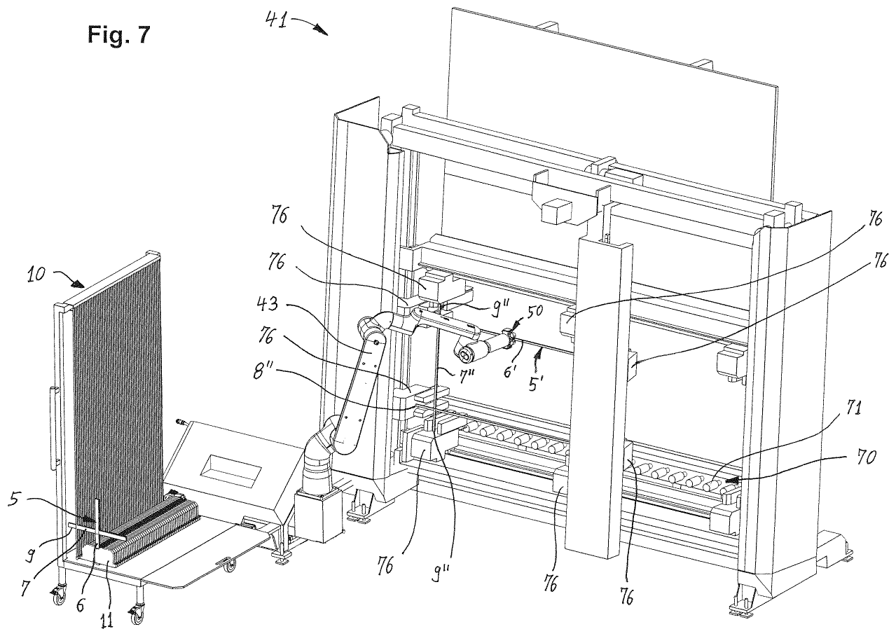

FIG. 7 shows an automatic muntin bar station 41 for inserting glazing bar inserts 5, 5′. The loaded transport trolley 10 is parked in a defined position at the muntin bar station 41. For this purpose, the transport trolley 10 has a coupling 42 for coupling to the muntin bar station 41. A robot arm 43 assigned to the muntin bar station 41 can then unload the glazing bar inserts 5, 5′ contained in the transport trolley and transfer them to the muntin bar station 41.

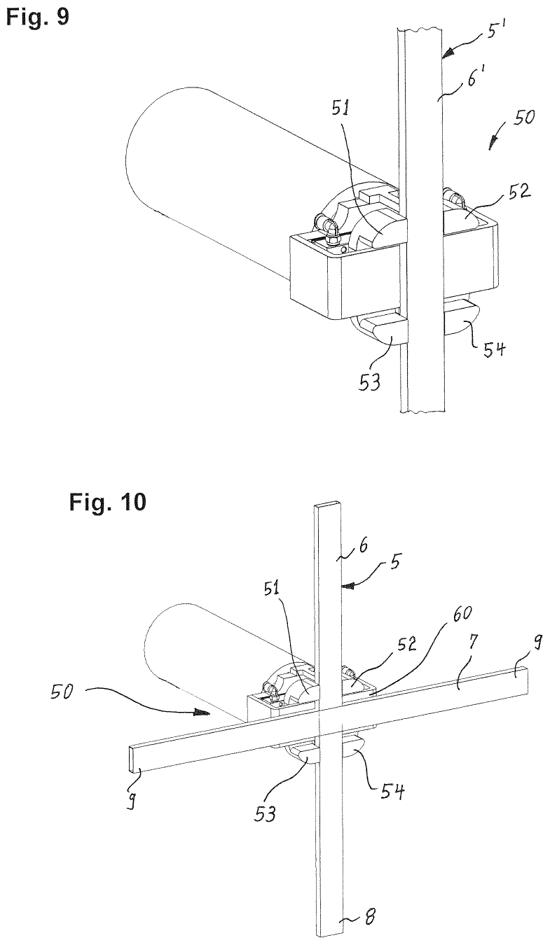

The robot arm 43 comprises a gripping device 50 shown in FIG. 8. The gripping device 50 has four gripping elements 51, 52, 53, 54 for gripping a muntin bar 6, 6′ in its center. The gripping elements 51 and 52 form a first gripper pair 55. The gripping elements 53 and 54 form a second gripper pair 56. The first gripping element 51 of the first gripper pair 55 is connected to the first gripping element 53 of the second gripper pair 56 via a connecting bridge 57. The second gripping element 52 of the first gripper pair 55 is connected to the second gripping element 54 of the second gripper pair 56 via a connecting bridge 58. The distance between the gripping elements 51, 52, 53, 54 can be varied by a pneumatic drive 59 along the double arrow D. Due to the coupling by the connecting bridges 57, 58, the two gripper pairs 55 and 56 open and close synchronously when a muntin bar 6′ is gripped by the gripping device 50, see FIG. 9. The second gripper pair 56 is spaced apart from the first gripper pair 55, which allows the muntin bar 6 to be gripped in its center, where the cross muntin bar 7 is located, see FIG. 10. A support 60 for the cross muntin bar 7 is arranged between the gripper pairs 55 and 56, which can stabilize the glazing bar insert 5 when the robot arm 43 moves. The gripping device 50 is attached to the robot arm 43 via a connection 61. Otherwise, the robot arm 43 is designed in a manner known per se and therefore does not need to be described in detail.

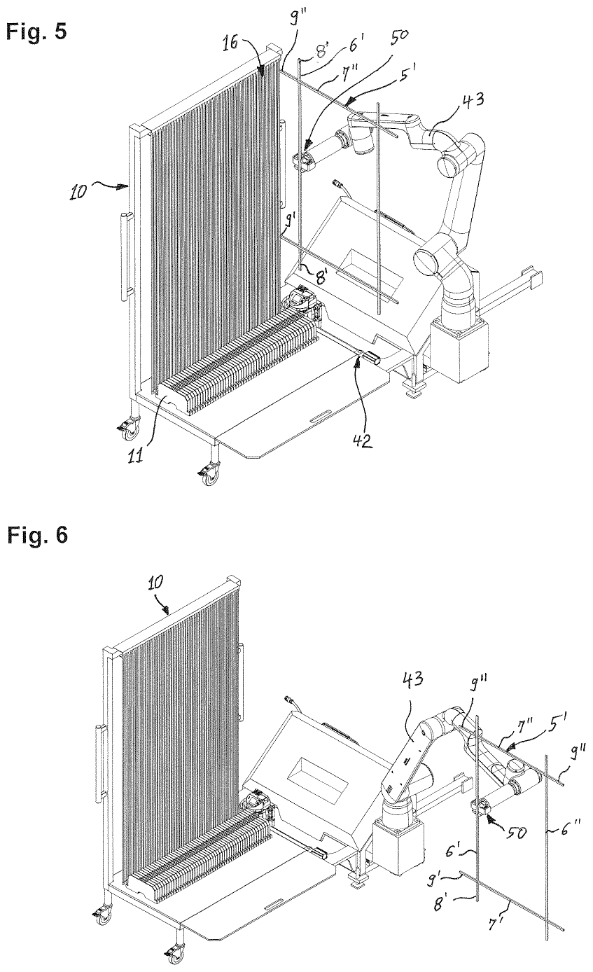

In order to have the glazing bar insert 5′ located in the transport carriage 10 inserted by the automatic muntin bar station 41 into a spacer 4, the robot arm 43 moves the gripping device 50 to the center of the muntin bar 6′, the lower free end 8′ of which is engaged with the holding device 11. The gripping device 50 grips the muntin bar 6′ as shown in FIG. 9 and lifts the glazing bar insert 5′ in a direction opposite to the loading direction B so that the lower free end 8′ of the muntin bar 6′ is pulled upward out of the holding device 11. This is shown in FIG. 5. In doing so, the muntin bar ends 9′ and 9″ located in the additional support 16 are guided upwards in the additional support 16. The robot arm 43 then moves the gripping device 50 transversely to the loading direction B and moves the muntin bar ends 9′ and 9″ out of the additional support 16, see FIG. 6. The glazing bar insert 5′ is still positioned upright. The robot arm 43 then rotates the gripping device 50 until the muntin bar 6′ extends horizontally.

The muntin bar station 41, see FIG. 7, contains one or more single-track horizontal conveyors 70, which are formed by a line of several drivable transport rollers 71. Such horizontal conveyors 70 are known per se. A glass plate 2 stands on the horizontal conveyor 70 with its lower edge. The muntin bar station 41 has a support wall 74, which, in a manner known per se, has an angle of 6° to 8° to the vertical in order to support the glass plate 2 leaning against it, which stands on the horizontal conveyor 70, and prevent it from accidentally falling forward. In FIG. 7, the glass plate 2 is conveyed into the muntin bar station 41 from the left, wherein its long side extends horizontally, see FIG. 1. The muntin bar station 41 contains several processing heads 76, which can be moved parallel to the support wall 74. The muntin bar station 41 contains several drives coupled to a control system for motorized displacement of the processing heads 76. Before the glazing bar insert 5′ is inserted, the processing heads 76 are moved to the positions required according to the dimensions of the glazing bar insert 5′ in order to accommodate its muntin bar ends 8′, 8″, 9′, and 9″. Now, the glazing bar insert 5′ can be transferred from the robot arm 43 to the muntin bar station 41. In the process, the muntin bar ends 8′, 8″, 9′, and 9″ are taken over by the processing heads 76 and the glazing bar insert 5′ is positioned parallel to the support wall 74. The gripping device 50 is then opened and moved away from the glazing bar insert 5′. The gripping device 50 is moved back to the transport trolley 10 by the robot arm 43 in order to unload the next glazing bar insert 5.

The processing heads 76 are moved together with the glazing bar insert 5′ held therein toward the support wall 74 and brought closer to the support wall 74 and the glass plate 2 standing there. The glazing bar insert 5′ oriented parallel to the glass plate 2 is inserted transversely to the glass plane into the space enclosed by the frame-shaped spacer 4 and inserted into the spacer 4. After fastening all muntin bar ends of the glazing bar insert 5′, all processing heads 76 are moved away from the support wall 74. The glass plate 2 with the glazing bar insert 5′ inserted into the spacer 4 is then conveyed out of the muntin bar station 41 by the horizontal conveyor 70. This frees up the muntin bar station 41 again so that it can insert the next glazing bar insert 5. The glass plate 2 is conveyed by the horizontal conveyor 70 to a pressing station (not shown) and joined in a known manner with the glass plate 3 to form the insulating glass pane 1 by placing the glass plate 3 on the narrow side of the spacer 4 and filling the space between the glass plates 2 and 3 with a gas other than air.

### LIST OF REFERENCE SYMBOLS

1 Insulating glass pane
2, 3 Glass panes
4 Spacer
5, 5′ glazing bar inserts
6, 6′, 6″ Muntin bars
7, 7′, 7″ Cross muntin bars
8, 8′, 8″ Muntin bar ends
9, 9′, 9″ Muntin bar ends
6 Transport trolley
7 Holding device
8 Frame
9 Rollers
10 Handles
11 Base plate
12 Additional support
13 Additional support
20 Housing
21 Base side
22 Loading side
23, 24 Side walls
25 Recess
26 Positioning stop
27 Cleaning channel
30 Muntin bar end holding mechanism
31, 32 Clamping devices
33, 34 Muntin bar clamps
35, 36 Muntin bar clamps
37 Axle
38 Sliding piece
39 Helical spring
40 Insertion region
41 Muntin bar station
42 Coupling
43 Robot arm
50 Gripping device
51, 52 Gripping elements
53, 54 Gripping elements
55, 56 Gripper pairs
57, 58 Connecting bridges
59 Gripping drive
60 Cross muntin bar support
61 Connection
70 Horizontal conveyor
71 Transport rollers
74 Support wall
76 Processing head
A Intersecting area
B Loading direction
C Extension direction
D Gripping movement

What is claimed is:

1. A holding device configured for holding a glazing bar insert for an insulating glass pane during a transport process, wherein the holding device comprises:
a muntin bar end holding mechanism with a loading direction;
wherein the loading direction extends along a muntin bar of a glazing bar insert loaded into the holding device.

2. The holding device according to claim 1, wherein the holding device comprises:
a housing with a base side;
a loading side opposite to the base side;
two side walls extending from the base side to the loading side;
wherein the loading direction is directed from the loading side to the base side; and
wherein the housing has a recess and/or an opening in the area of the base side for a muntin bar end engaged with the holding device.

3. The holding device according to claim 1, wherein the muntin bar end holding mechanism comprises at least one clamping device for clamping a glazing bar insert engaged with the holding device in the region of a free muntin bar end.

4. The holding device according to claim 3, wherein the clamping device has an insertion region that tapers in loading direction.

5. The holding device according to claim 3, wherein the clamping device comprises at least two opposing muntin bar clamps, wherein at least one of the muntin bar clamps is movable transversely to the loading direction.

6. The holding device according to claim 3, wherein the glazing bar end holding mechanism has a first clamping device and a second clamping device arranged in the loading direction behind the first clamping device.

7. A transport trolley configured for transporting a plurality of glazing bar inserts for insulating glass panes, wherein the transport trolley has a loading direction and a plurality of holding devices arranged next to each other transversely to the loading direction, each for one glazing bar insert, wherein each of the holding devices is assigned a positioning stop which defines the position of a glazing bar insert comprising at least one muntin bar, once a free end of said at least one muntin bar has been brought into engagement with this holding device along the loading direction during loading.

8. The transport trolley according to claim 7, wherein the loading direction is oriented vertically downward where a lower free end of a vertically extending muntin bar can be engaged with one of the holding devices.

9. The transport trolley according to claim 7, wherein the transport trolley has a cleaning channel configured for the positioning stop.

10. The transport trolley according to claim 7, wherein the transport trolley has at least one additional support for glazing bar inserts.

11. The transport trolley according to claim 7, wherein the transport trolley has at least one coupling for coupling the transport trolley to an automatic muntin bar station.

12. A method for transporting a glazing bar insert in connection with the manufacture of an insulating glass pane, comprising the following steps:
providing a glazing bar insert comprising at least one muntin bar which is positioned where the at least one muntin bar extends vertically;
loading a holding device with the glazing bar insert by bringing a free end of said at least one muntin bar into engagement with the holding device along a loading direction until the glazing bar insert rests against a positioning stop associated with the holding device;
transporting the holding device with the glazing bar insert to an automatic muntin bar station;
unloading the glazing bar insert by taking it out from the holding device with a gripping device in the opposite direction to the loading direction and then rotating it until said at least one muntin bar extends horizontally; and
inserting the glazing bar insert by the automatic muntin bar station into a frame-shaped spacer, wherein the at least one muntin bar extends horizontally.

13. The method according to claim 12, comprising the following further steps:
when loading the holding device, inserting a lower free end of the at least one muntin bar into the holding device from above;
for unloading, gripping the muntin bar held in the holding device by its lower free end in its middle section by the gripping device, and pulling the glazing bar insert upwards out of the holding device; and
rotating the glazing bar insert by the gripping device until the muntin bar held therein extends horizontally.

14. The method according to claim 12, wherein the gripping device is rotatably mounted on a movable robot arm.

15. The method according to claim 12, wherein the gripping device grips the muntin bar held in the holding device with two pairs of grippers spaced apart from each other, each gripper pair containing two gripping elements which are moved closer to each other when gripping the muntin bar.
